(19) United States
(12) Patent Application Publication
(10) Pub. No.: US 2026/0156381 A1
(43) Pub. Date: Jun. 4, 2026

(54) IMAGE SIGNAL PROCESSOR

(71) Applicant: SK hynix Inc., Gyeonggi-do (KR)

(72) Inventors: Jun Hyeok CHOI, Gyeonggi-do (KR); Dong Ik KIM, Gyeonggi-do (KR); Jin Na YANG, Gyeonggi-do (KR); Cheol Jon JANG, Gyeonggi-do (KR)

(21) Appl. No.: 19/185,271

(22) Filed: Apr. 22, 2025

(30) Foreign Application Priority Data
Dec. 2, 2024 (KR) 10-2024-0176381

(51) Int. Cl. H04N 25/683; H04N 25/70

(52) U.S. Cl. CPC H04N 25/683; H04N 25/70

(57) ABSTRACT

An image signal processor for performing image conversion is disclosed. The image signal processor includes a kernel generator configured to generate a target kernel including a pair of adjacent target pixels; a texture determiner configured to determine whether the target kernel corresponds to a flat region or a dark region by analyzing a texture of the target kernel; a threshold setting circuit configured to determine a threshold based on a result of the determination of the texture determiner; a defective pixel determiner configured to determine, based on pixel data of reference pixels having a same attribute as the pair of target pixels, whether each of the target pixels is defective pixel; and a defective pixel corrector configured to correct one of the pair of target pixels when the target pixels are determined as defective pixels.

### CROSS-REFERENCE TO RELATED APPLICATION

The present application claims the priority and benefits of Korean patent application No. 10-2024-0176381, filed on Dec. 2, 2024, which is herein incorporated by reference in its entirety.

### TECHNICAL FIELD

The technology and embodiments of the present disclosure generally relate to an image signal processor capable of performing image conversion.

### BACKGROUND

An image sensing device is a device for capturing optical images by converting light into electrical signals using a photosensitive semiconductor material which reacts to light. With the development of automotive, medical, computer and communication industries, the demand for high-performance image sensing devices is increasing in various fields such as smartphones, digital cameras, game machines, IoT (Internet of Things), robots, surveillance cameras and medical micro cameras.

An original image captured by the image sensing device may include an original defect or an image of defective pixels that do not correspond to a normal image due to temporary factors. In general, when a defective pixel exists in an image sensor, a device that can interpolate data of the defective pixel by using data of neighboring pixels located around the defective pixel may be used. However, when two or more defective pixels are continuously arranged adjacent to each other in the image sensing device, data of another defective pixel is used when correcting the defective pixel, so that the defective pixel may be incorrectly corrected.

### SUMMARY

Various embodiments of the present disclosure relate to an image signal processor capable of effectively correcting a pixel value of a defective pixel even when two or more defective pixels exist adjacent to each other.

In accordance with an embodiment of the present disclosure, an image signal processor may include a kernel generator configured to generate a target kernel including a pair of adjacent target pixels; a texture determiner configured to determine whether the target kernel corresponds to a flat region or a dark region by analyzing a texture of the target kernel; a threshold setting circuit configured to determine a threshold based on a result of the determination of the texture determiner; a defective pixel determiner configured to determine, based on pixel data of reference pixels having a same attribute as the pair of target pixels, whether each of the target pixels is defective pixel; and a defective pixel corrector configured to correct one of the target pixels when the target pixels are determined as defective pixels.

In accordance with another embodiment of the present disclosure, an image signal processor may include a texture determiner configured to determine kernel type information by analyzing a texture of a target kernel including a pair of adjacent target pixels; a threshold setting circuit configured to determine a threshold based on the kernel type information; a defective pixel determiner configured to determine, based on the threshold, whether each of the pair of target pixels is a defective pixel; and a defective pixel corrector configured to correct one of the target pixels when the target pixels are determined as defective pixels.

It is to be understood that both the foregoing general description and the following detailed description of the present disclosure are illustrative and descriptive and are intended to provide further description of the embodiments as claimed.

### BRIEF DESCRIPTION OF THE DRAWINGS

The above and other features and beneficial aspects of the present disclosure will become readily apparent with reference to the following detailed description when considered in conjunction with the accompanying drawings.

FIG. 1 is a block diagram illustrating an image signal processor based on some embodiments of the present disclosure.

FIG. 2 is a block diagram illustrating the defective pixel detector shown in FIG. 1 based on some embodiments of the present disclosure.

FIG. 3 is a diagram illustrating kernels generated by a kernel generator shown in FIG. 2 based on some embodiments of the present disclosure.

FIG. 4 is a diagram illustrating operations of determining a texture by a texture determiner shown in FIG. 2 based on some embodiments of the present disclosure.

FIG. 5 is a diagram illustrating operations of determining defective pixels by a defective pixel determiner shown in FIG. 2 based on some embodiments of the present disclosure.

FIG. 6 is a diagram illustrating operations of correcting defective pixels by a defective pixel corrector shown in FIG. 1 based on some embodiments of the present disclosure.

FIG. 7 is a diagram illustrating operations of correcting defective pixels by the defective pixel corrector shown in FIG. 1 based on some embodiments of the present disclosure.

FIG. 8 is a flowchart illustrating operations of the image signal processor shown in FIG. 1 based on some embodiments of the present disclosure.

FIG. 9 is a block diagram illustrating a computing device corresponding to the image signal processor of FIG. 1 based on some embodiments of the present disclosure.

### DETAILED DESCRIPTION

The present disclosure provides embodiments and examples of an image signal processor capable of performing image conversion that may be used in configurations to substantially address one or more technical or engineering issues and to mitigate limitations or disadvantages encountered in some other image signal processors. Some embodiments of the present disclosure relate to an image signal processor capable of effectively correcting a pixel value of a defective pixel even when two or more defective pixels exist adjacent to each other. In recognition of the issues above, the image signal processor based on some embodiments of the present disclosure can more accurately detect and correct defective pixels even when two or more defective pixels exist adjacent to each other.

Reference will now be made in detail to some embodiments of the present disclosure, which are illustrated in the accompanying drawings. Wherever possible, the same reference numbers will be used throughout the drawings to refer to the same or like parts. While this disclosure is susceptible to various modifications and alternative forms, specific embodiments thereof are shown in the drawings. However, the embodiments should not be construed as being limited to the embodiments set forth herein.

Hereinafter, various embodiments will be described with reference to the accompanying drawings. However, it should be understood that the present invention is not limited to specific embodiments, but includes various modifications, equivalents and/or alternatives of the embodiments. The embodiments of the present disclosure may provide a variety of effects capable of being directly or indirectly recognized.

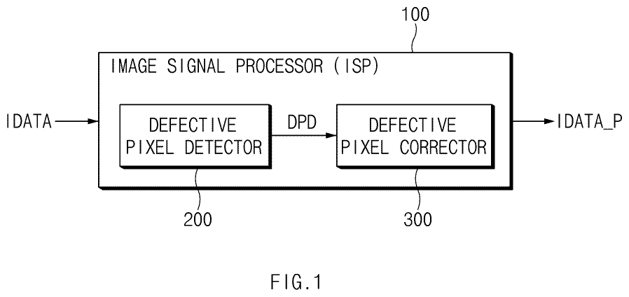

FIG. 1 is a block diagram illustrating an image signal processor (ISP) 100 based on some embodiments of the present disclosure.

Referring to FIG. 1, the image signal processor (ISP) 100 may perform at least one image signal process on image data (IDATA) to generate the corrected image data (IDATA_P).

The image signal processor 100 may reduce noise of image data (IDATA), and may perform various kinds of image signal processing (e.g., demosaicing, defect pixel correction, gamma correction, color filter array interpolation, color matrix, color correction, color enhancement, lens distortion correction, etc.) for image-quality improvement of the image data.

In addition, the image signal processor 100 may compress image data that has been created by execution of image signal processing for image-quality improvement, such that the image signal processor 100 can create an image file using the compressed image data. Alternatively, the image signal processor 100 may recover image data from the image file. In this case, the scheme for compressing such image data may be a reversible format or an irreversible format. As a representative example of such compression format, in the case of using a still image, Joint Photographic Experts Group (JPEG) format, JPEG 2000 format, or the like can be used. In addition, in the case of using moving images, a plurality of frames can be compressed according to Moving Picture Experts Group (MPEG) standards such that moving image files can be created.

The image data (IDATA) may be generated by an image sensing device that captures an optical image of a scene, but the embodiment is not limited thereto. The image sensing device may include a pixel array including a plurality of pixels configured to sense incident light received from a scene, a control circuit configured to control the pixel array, and a readout circuit configured to output digital image data (IDATA) by converting an analog pixel signal received from the pixel array into the digital image data (IDATA). In some embodiments of the present disclosure, the image data (IDATA) is generated by the image sensing device.

The pixel array may include a color filter array (CFA) in which color filters are arranged according to a predetermined pattern (e.g., a Bayer pattern, a quad-Bayer pattern, nona-Bayer pattern, an RGBW pattern, etc.) so that each color filter can sense light of a predetermined wavelength band. The pattern of the image data (IDATA) may be determined according to the type of the pattern of the CFA. The word “predetermined” as used herein with respect to a parameter, such as a predetermined pattern, threshold, size, distance, condition, algorithm, and wavelength band, means that a value of the parameter is determined prior to the parameter being used in a process or algorithm. For some embodiments, the value of the parameter is determined before the process or algorithm begins. In other embodiments, the value of the parameter is determined during the process or during execution of the algorithm but before the parameter is used in the process or algorithm.

The image signal processor (ISP) 100 according to the embodiment of the present disclosure may include a defective pixel detector 200 and a defective pixel corrector 300.

The defective pixel detector 200 may detect a defective pixel using image data (IDATA). The defective pixel detector 200 may detect a defective pixel and may output defective pixel data (DPD) to the defective pixel corrector 300.

The defective pixel may refer to a pixel that does not normally generate pixel data corresponding to the intensity of incident light. The defective pixel may be a predetermined fixed defective pixel (e.g., a phase-difference detection autofocus (PDAF) pixel, a defective pixel having a defect due to manufacturing process limitations, etc.) according to pixel attributes, or may be a defective pixel which temporarily cannot generate normal pixel data due to environmental or structural causes. Here, the PDAF pixel may be a pixel for obtaining phase difference information to implement an autofocus function, and may be classified as a defective pixel from the viewpoint of image data processing.

The defective pixel detector 200 may detect position information of a defective pixel from image data (IDATA).

In some embodiments, for convenience of description, digital data corresponding to a pixel signal of each pixel will hereinafter be defined as pixel data, and a set (aggregate) of pixel data corresponding to a predetermined unit (e.g., a frame or kernel) will hereinafter be defined as image data (IDATA). Here, the frame may correspond to the entire pixel array, and the kernel may refer to a unit for image signal processing. In the present embodiments, if pixels are included in a kernel, this may mean an example case in which the corresponding pixels are arranged to correspond to the kernel corresponding to a specific operation unit.

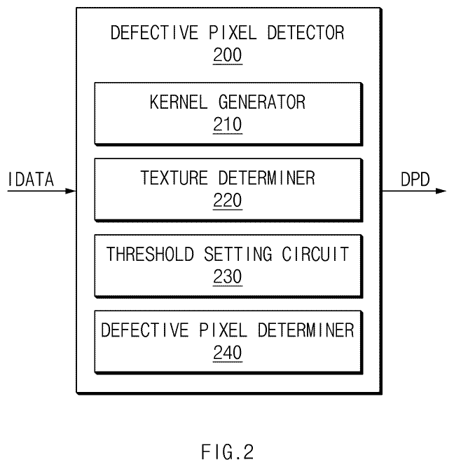

The defective pixel detector 200 may receive pre-stored position information of defective pixels from the image sensing device that generates image data (IDATA) and may determine whether the target pixel is a defective pixel based on the position information of the defective pixels. The image sensing device may store position information of fixed-position defective pixels generated during a fabrication process in an internal storage (e.g., one time programmable (OTP) memory), and may provide the position information of the defective pixels to the image signal processor 100. More detailed operations of the defective pixel detector 200 will be described later with reference to FIG. 2.

When the target pixel is determined to be a defective pixel by the defective pixel detector 200, the defective pixel corrector 300 may correct pixel data of the target pixel based on image data of a kernel including the target pixel. In this case, the pixel data of the target pixel may mean normal color pixel data that can be obtained if the target pixel is not a defective pixel.

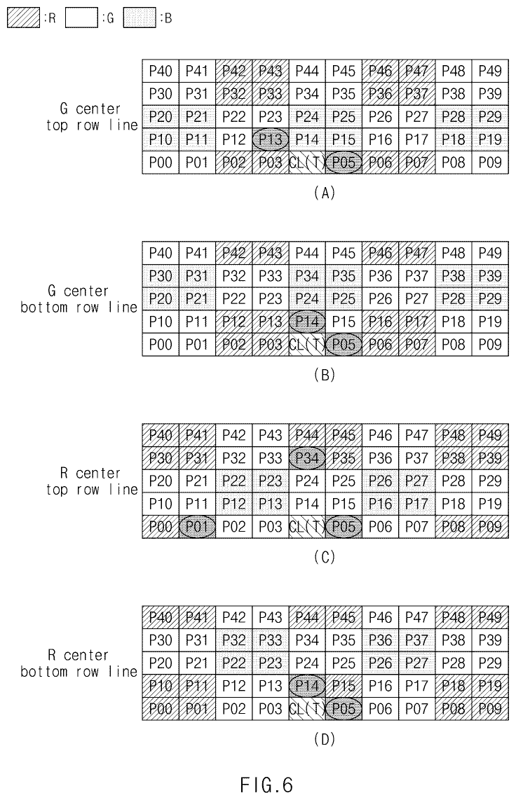

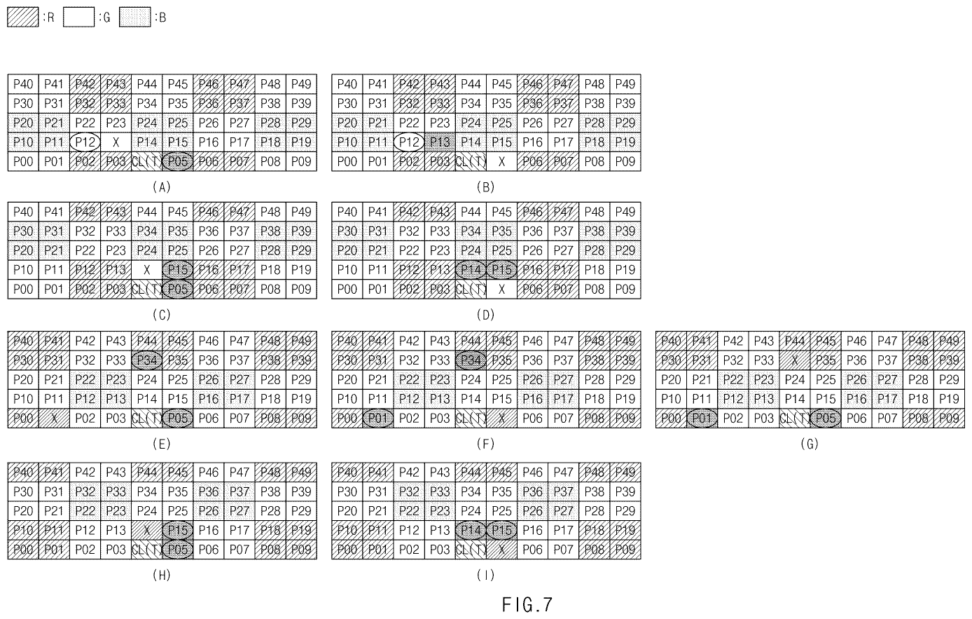

In an embodiment, the defective pixel corrector 300 may correct the pixel data of the target pixel using the pixel data of pixels that have the same attributes as the target pixel from among the pixels included in the kernel. In another embodiment, the defective pixel corrector 300 may perform defective pixel correction in units of a mask having a predetermined size. In this case, the defective pixel correction may be an operation of calculating (e.g., linearly interpolating) pixel data of at least one pixel that is the same type (homogeneous) as (and/or a different type (heterogeneous) from) a target pixel within a mask structured such that the target pixel to be corrected is located at a center of the mask, and then obtaining pixel data corresponding to the target pixel. More detailed operations of the defective pixel corrector 300 will be described later with reference to FIGS. 6 and 7.

FIG. 2 is a block diagram illustrating the defective pixel detector 200 shown in FIG. 1 based on some embodiments of the present disclosure.

Referring to FIG. 2, the defective pixel detector 200 may include a kernel generator 210, a texture determiner 220, a threshold setting circuit 230, and a defective pixel determiner 240.

The kernel generator 210 may generate a kernel for determining a defective pixel from pixel data included in image data (IDATA). The kernel generated by the kernel generator 210 may move within the input image.

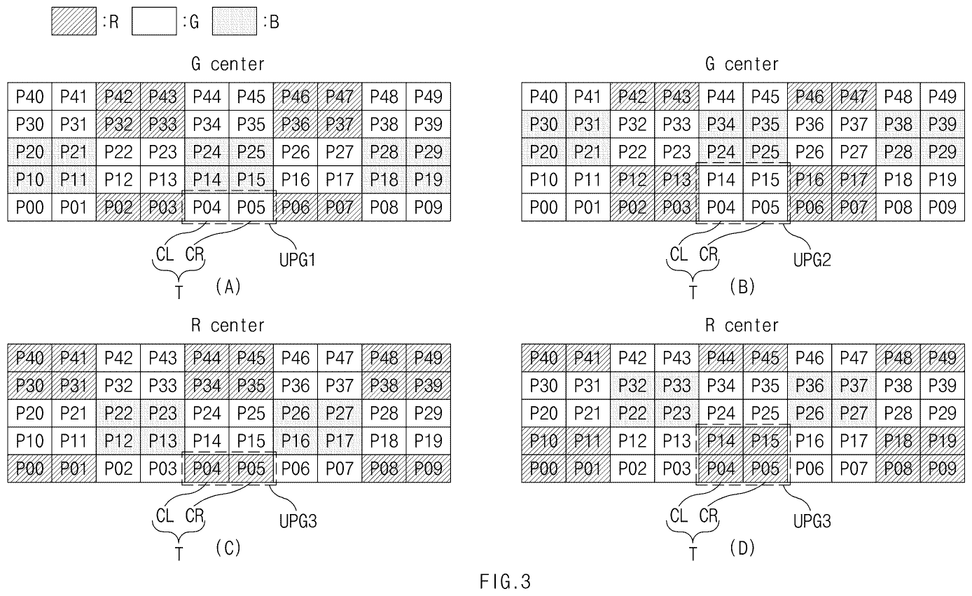

For example, the kernel generator 210 may generate an operation kernel to detect a defective pixel while moving pixels in units of two pixels from the beginning to the end of the pixels. Examples of kernels that may be generated by the kernel generator 210 will be described in more detail with reference to FIG. 3 to be described below.

The texture determiner 220 may analyze a texture for each kernel based on the image data (IDATA). Image data (IDATA) corresponding to one frame may include textures of various sizes and shapes. The texture refers to a set (or aggregate) of pixels having similarity, and for example, a target object having a uniform color included in a scene may be recognized as a texture.

The texture may be one of characteristics indicating whether the target kernel is a flat region, an edge (or corner) region, or a more complex pattern region than the edge region. Here, the target kernel may include a target pixel to be corrected, and may mean a unit for image signal processing. The flat region may refer to a region in which the target kernel has very similar pixel data overall without having specific directionality, so that the flat region may be considered to be a texture region that is simpler than the edge region. In addition, the texture may be one of the characteristics indicating whether or not the target kernel is a dark region. The dark region may mean a texture region where the target kernel is darker than a preset brightness.

The texture determiner 220 may analyze the texture to determine whether the target kernel including the target pixel is a flat region or a dark region. In one embodiment, the texture determiner 220 may also function as a flat kernel determiner or a dark kernel determiner. Here, the target kernel may correspond to a target kernel for determining a flat region or a dark region from among a set of pixel data of a predetermined unit including pixel data of the target pixel.

When the target kernel does not correspond to a predetermined pattern shape, the texture determiner 220 may determine the target kernel to be a flat region. Here, the predetermined pattern shape may represent a corner pattern, an edge pattern, etc. For example, when the standard deviation of pixel value of each of the pixels included in the target kernel is less than a set value, the texture determiner 220 may determine the target kernel to be a flat region. The set value may correspond to a value pre-stored in the image signal processor (ISP) 100 to determine the type of a kernel. In another embodiment, the texture determiner 220 may determine whether the target kernel belongs to a flat region by setting a threshold based on a median value of pixels included in the target kernel.

The texture determiner 220 may determine brightness of the kernel based on each pixel datum in the target kernel. For example, the texture determiner 220 may determine whether the target kernel is a dark region by calculating a median value using the pixel values of green pixels located around the target pixel. In this disclosure, a pixel value of a pixel may be regarded as a value of pixel data of the pixel.

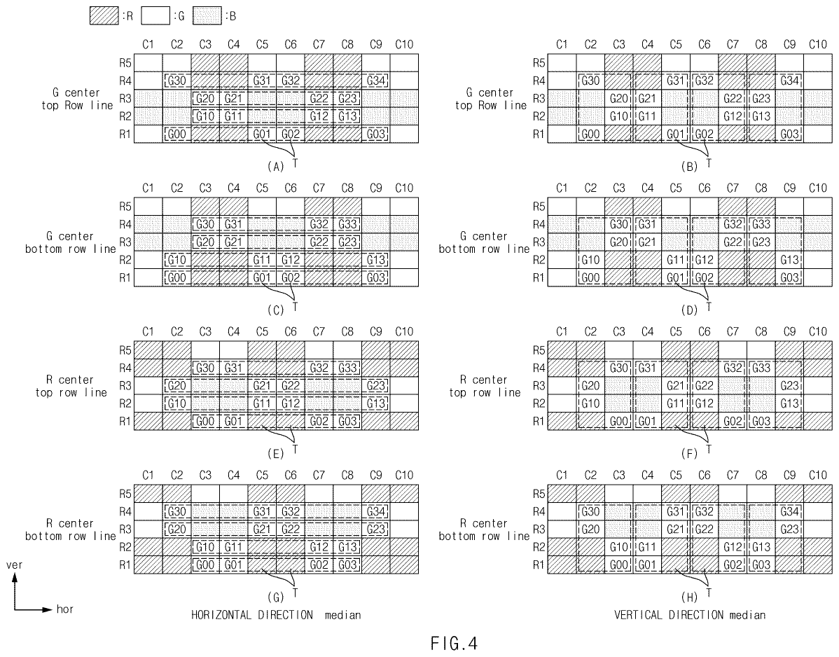

The texture determiner 220 may transmit kernel type information of the target kernel to the threshold setting circuit 230. For example, the texture determiner 220 may transmit the kernel type information indicating whether the target kernel is a flat region or a dark region to the threshold setting circuit 230. An embodiment of determining the texture by the texture determiner 220 will be described in more detail with reference to FIG. 4 to be described below.

The threshold setting circuit 230 may receive the kernel type information from the texture determiner 220, and may determine (or set) a threshold that serves as a reference value for detecting a defective pixel. In one embodiment, the threshold setting circuit 230 may determine (or set) the threshold in different ways based on the kernel type information of the target kernel.

The threshold setting circuit 230 may determine (or set) the first threshold when the target kernel is determined to be a flat region. For example, when the target kernel is a flat region, the first threshold may be set based on brightness of the target pixel. That is, the threshold setting circuit 230 may also determine a specific ratio of a brightness value of the current kernel (e.g., the average pixel value of green pixels). In another embodiment, the threshold setting circuit 230 may determine (or set) the first threshold based on the standard deviation of pixel value of each pixel located within the target kernel. In another embodiment, the threshold setting circuit 230 may determine (or set) the first threshold by comparing the standard deviation of pixel value of each pixel located in the same channel within the target kernel with the standard deviation of pixel value of each pixel located within the target kernel. In another embodiment, the threshold setting circuit 230 may determine (or set) the first threshold based on a median value obtained by the texture determiner 220. In another embodiment, the threshold setting circuit 230 may determine (or set) the first threshold based on pixel values of the same pixels (i.e., homogeneous pixels) having the same attributes as the target pixel.

The threshold setting circuit 230 may determine (or set) the second threshold when the target kernel is determined to be a dark region. For example, the threshold setting circuit 230 may determine the second threshold as a fixed constant when the target kernel is determined to be a dark region.

The threshold setting circuit 230 may transfer threshold information including the set threshold to the defective pixel determiner 240. For example, the threshold setting circuit 230 may transfer threshold information (i.e., a first threshold) corresponding to the target kernel serving as a flat region or threshold information (i.e., a second threshold) corresponding to the target kernel serving as a dark region to the defective pixel determiner 240.

The defective pixel determiner 240 may receive threshold information and may determine whether the target pixel is a “couplet defective pixel”. Here, a couplet defective pixel may refer to a pair of defective pixels located adjacent to each other.

In one embodiment, the defective pixel determiner 240 may determine a defective pixel by using the brightness difference between a target pixel and reference pixels having the same color as the target pixel. Here, the target pixel may indicate a target object to be determined as the defective pixel or a normal pixel. In addition, the reference pixels may correspond to a plurality of neighboring pixels other than a target pixel channel serving as a target of defect correction.

The defective pixel determiner 240 may compare pixel data of the target pixel with pixel data of the reference pixels. The defective pixel determiner 240 may compare the first threshold or the second threshold with a difference value obtained when the pixel data of the target pixel is compared with the pixel data of the reference pixels and may determine whether the target pixel is a couplet defective pixel.

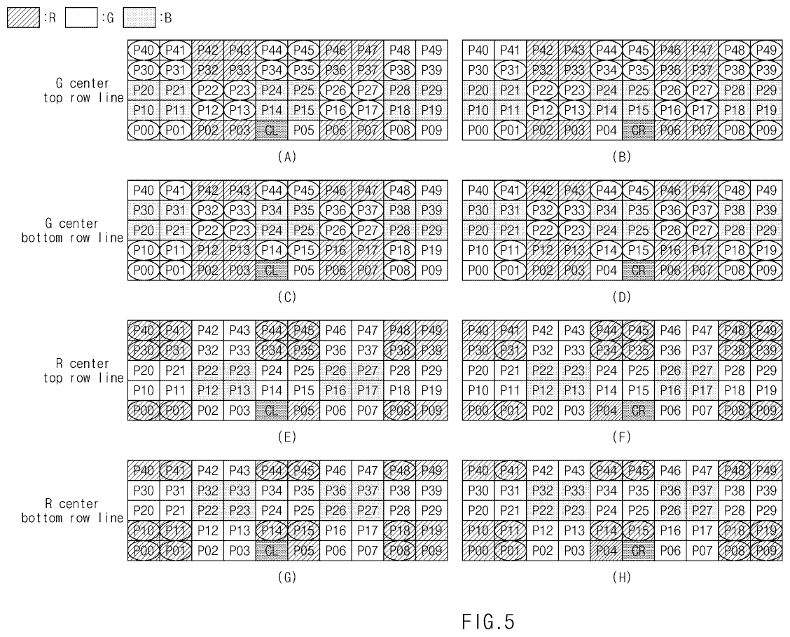

When the target pixel is determined to be a couplet defective pixel, the defective pixel determiner 240 may generate the defective pixel data (DPD) including both coordinate information of the target pixel and pixel data of the target pixel. In one embodiment, the defective pixel data (DPD) may include information indicating whether the defective pixel is included in a target kernel that is a flat region or in a target kernel that is a dark region. The method of determining a defective pixel will be described in detail later with reference to FIG. 5.

FIG. 3 is a diagram illustrating kernels generated by the kernel generator 210 shown in FIG. 2 based on some embodiments of the present disclosure.

Referring to FIG. 3, a kernel generated by the kernel generator 210 according to the present disclosure may include (M×N) pixels arranged in a matrix structure. Here, M and N are different natural numbers, and M may be a natural number greater than N. As the size of the kernel increases, resources required for detection and correction of defective pixels may increase. As a result, a kernel having a horizontal size and a vertical size smaller than the horizontal size may be used to reduce resources. That is, kernels according to embodiments of the present disclosure may correspond to asymmetric kernels, each of which has a horizontal size and a vertical size smaller than the horizontal size.

As an example, the kernel generated by the kernel generator 210 is a unit of a (10×5) kernel having 10 rows and 5 columns. In the target kernel, green (G) color filters, red (R) color filters, and blue (B) color filters may be arranged in a quad-Bayer pattern. Values of one color from among the green (G) color, the red (R) color, and the blue (B) color may be matched to each of four unit pixel groups (UPGs) arranged in (2×2) matrix, resulting in formation of a (10×5) kernel.

Although the embodiment of the present disclosure has disclosed that the kernel is arranged in the quad-Bayer pattern for convenience of description, the technical idea of the present disclosure can also be applied to another kernel in which color pixels are arranged in other patterns such as a nona-Bayer pattern, a hexa-Bayer pattern, an RGBW pattern, a mono pattern, etc., and the types of image patterns are not limited thereto and can also be suitably changed as needed. In addition, a kernel having another size other than the (10×5) size may also be used depending on performance of the image signal processor (ISP) 100, required correction accuracy, an arrangement method of color pixels, and the like, but the unit of the kernel is not limited.

The embodiments illustrated in FIGS. 3(A) and 3(B) may represent example cases in which the target kernel includes a target pixel (T) corresponding to a green (G) color filter. In addition, the embodiments illustrated in FIGS. 3(C) and 3(D) may represent example cases in which the target kernel includes a target pixel (T) corresponding to a specific color filter. For example, the specific color filter may be a red (R) color filter, a blue (B) color filter, etc., but the red (R) color filter will hereinafter be described as a representative example for convenience of description.

In each of FIGS. 3(A) to 3(D), pixels (P00˜P49) may constitute a (10×5) kernel. The pixels (P00˜P49) included in the target kernel may be grouped into a plurality of unit pixel groups. For example, each of the plurality of unit pixel groups may include pixels that correspond to the same color filter and are adjacent to each other. For example, pixels (P30, P31, P40, P41) corresponding to the green (G) color filter and adjacent to each other may be grouped into one unit pixel group. Pixels (P32, P33, P42, P43) corresponding to a red (R) color filter and adjacent to each other may be grouped into another unit pixel group. Pixels (P10, P11, P20, P21) corresponding to a blue (B) color filter and adjacent to each other may be grouped into another unit pixel group. It can be understood that the remaining pixels included in the target kernel are also grouped in the same manner as described above.

In the target kernel, the target pixel (T) may correspond to a pair of pixels (P04, P05) located at the center of the lowermost row. The target pixel (T) may be a pair of pixels (P04, P05) arranged adjacent to each other. Among the pair of pixels (P04, P05), the target pixel arranged on the left side may be defined as a left pixel (CL), and the target pixel arranged on the right side may be defined as a right pixel (CR).

Referring to the kernel shown in FIG. 3(A), the target pixel (T) may be located in a (2×1) unit pixel group (UPG1) corresponding to the green (G) color filter. Referring to the kernel shown in FIG. 3(B), the target pixel (T) may be located in pixels included in a lower row of the (4×4) unit pixel group (UPG2) corresponding to the green (G) color filter. Referring to the kernel shown in FIG. 3(C), the target pixel (T) may be located in a (2×1) unit pixel group (UPG3) corresponding to the red (R) color filter. Referring to the kernel shown in FIG. 3(D), the target pixel (T) may be located in pixels included in a lower row of the (4×4) unit pixel group (UPG4) corresponding to the red (R) color filter.

FIG. 4 is a diagram illustrating operations of determining a texture by the texture determiner 220 shown in FIG. 2 based on some embodiments of the present disclosure.

FIGS. 4(A) and 4(B) may represent example cases in which the target kernel corresponds to a green (G) color filter and includes a target pixel (T) arranged in a top row line, as illustrated in FIG. 3(A). FIGS. 4(C) and 4(D) may represent example cases in which the target kernel corresponds to a green (G) color filter and includes a target pixel (T) arranged in a bottom row line, as illustrated in FIG. 3(B).

FIGS. 4(E) and 4(F) may represent example cases in which the target kernel corresponds to a red (R) color filter and includes a target pixel (T) arranged in a top row line, as illustrated in FIG. 3(C). FIGS. 4(G) and 4(H) may represent example cases in which the target kernel corresponds to a red (R) color filter and includes a target pixel (T) arranged in a bottom row line, as illustrated in FIG. 3(D).

In the present disclosure, the texture determiner 220 may determine whether, among pixels included in the target kernel, the target kernel corresponds to a flat region or a dark region by using the median value of a plurality of green color pixels that includes the target pixel (T) and is arranged adjacent to the target pixel (T).

For example, the texture determiner 220 may calculate the median value by grouping the plurality of green color pixels into a predetermined number of adjacent pixels arranged in a specific direction. Here, the method of calculating the median value may be performed by sorting the pixel values included in the target kernel in order of magnitude and then extracting the median value based on the sorted result, but the scope or spirit of the calculation method is not limited thereto. For example, if there are a total of four pixels to be calculated, the median value may be obtained by calculating the average of the second largest pixel value and the third largest pixel value from among the four pixel values.

Since two defective pixels may exist among the grouped pixels, the texture determiner 220 may group the pixels in at least two different directions in a manner that there are no two defective pixels in the grouped pixels. That is, the texture determiner 220 may group pixels in each of the horizontal direction (hor) and the vertical direction (ver), and may perform a calculation operation for each pixel group.

According to one embodiment of the present disclosure, a total of 16 green pixels from among the green pixels arranged in the rows (R1˜R4) are used for the calculation operation, but the embodiment is not limited thereto, and the number of pixels used for the calculation operation can also be suitably changed to another number.

FIGS. 4(A), 4(C), 4(E), and 4(G) may represent example cases in which the respective green pixels are grouped in the horizontal direction. That is, the texture determiner 220 may use the green pixels arranged in the rows (R1˜R4) from among the multiple rows (R1˜R5) for such calculation.

The texture determiner 220 may calculate the median value by grouping four green pixels (G00, G01, G02, G03) arranged in the center region from among the green pixels of the row (R1) in the target kernel. The median value (med1ₕₒᵣ) calculated based on the green pixels (G00, G01, G02, G03) grouped in the horizontal direction within the row (R1) may be represented by Equation 1 below.

$$med {1}_{hor} = med ( G 00 , G 01 , G 02 , G 03 ) \qquad [ Equation 1 ]$$

The texture determiner 220 may calculate the median value by grouping four green pixels (G10, G11, G12, G13) arranged in the center region from among the green pixels of the row (R2) in the target kernel. The median value (med2ₕₒᵣ) calculated based on the green pixels (G10, G11, G12, G13) grouped in the horizontal direction within the row (R2) may be represented by Equation 2 below.

$$m e d {2}_{hor} = med ( G 10 , G 11 , G 12 , G 13 ) \qquad [ Equation 2 ]$$

The texture determiner 220 may calculate the median value by grouping four green pixels (G20, G21, G22, G23) arranged in the center region from among the green pixels of the row (R3) in the target kernel. The median value (med3ₕₒᵣ) calculated based on the green pixels (G20, G21, G22, G23) grouped in the horizontal direction within the row (R3) may be represented by Equation 3 below.

$$med {3}_{hor} = med ( G 20 , G 21 , G 22 , G 23 ) \qquad [ Equation 3 ]$$

The texture determiner 220 may calculate the median value by grouping four green pixels (G30, G31, G32, G33) arranged in the center region from among the green pixels of the row (R4) in the target kernel. The median value (med4ₕₒᵣ) calculated based on the green pixels (G30, G31, G32, G33) grouped in the horizontal direction in the row (R4) may be represented by Equation 4 below.

$$med {4}_{hor} = med ( G 30 , G 31 , G 32 , G 33 ) \qquad [ Equation 4 ]$$

The texture determiner 220 may determine a maximum value from among the horizontal median values (med1ₕₒᵣ, med2ₕₒᵣ, med3ₕₒᵣ, med4ₕₒᵣ) calculated by Equations 1 to 4, to be a representative horizontal median value (medₕₒᵣ).

FIGS. 4(B), 4(D), 4(F), and 4(H) may represent example cases in which the respective green pixels are grouped in the vertical direction. That is, the texture determiner 220 may use the green pixels arranged in the columns (C2˜C9) from among the multiple columns (C1˜C10) for such calculation.

The texture determiner 220 may calculate the median value by grouping four green pixels (G00,G10,G20,G30) from among the green pixels of the columns (C2, C3) in the target kernel. The median value (med1ᵥₑᵣ) calculated based on the green pixels (G00, G10, G20, G30) grouped in the vertical direction within the columns (C2, C3) may be represented by Equation 5 below.

$$med {1}_{hor} = med ( G 00 , G 10 , G 20 , G 30 ) \qquad [ Equation 5 ]$$

The texture determiner 220 may calculate the median value by grouping four green pixels (G00,G10,G20,G30) from among the green pixels of the columns (C4, C5) in the target kernel. The median value (med2ᵥₑᵣ) calculated based on the green pixels (G01, G11, G21, G31) grouped in the vertical direction within the columns (C4, C5) may be represented by Equation 6 below.

$$med {2}_{hor} = med ( G 01 , G 11 , G 21 , G 31 ) \qquad [ Equation 6 ]$$

The texture determiner 220 may calculate the median value by grouping four green pixels (G00,G10,G20,G30) from among the green pixels of the columns (C6, C7) in the target kernel. The median value (med3ᵥₑᵣ) calculated based on the green pixels (G02, G12, G22, G32) grouped in the vertical direction within the columns (C6, C7) may be represented by Equation 7 below.

$$med {3}_{ver} = med ( G 02 , G 12 , G 22 , G 32 ) \qquad [ Equation 7 ]$$

The texture determiner 220 may calculate the median value by grouping four green pixels (G00,G10,G20,G30) from among the green pixels of the columns (C8, C9) in the target kernel. The median value (med4ᵥₑᵣ) calculated based on the green pixels (G03, G13, G23, G33) grouped in the vertical direction within the columns (C8, C9) may be represented by Equation 8 below.

$$med {4}_{ver} = med ( G 03 , G 13 , G 23 , G 33 ) \qquad [ Equation 8 ]$$

The texture determiner 220 may determine a maximum value from among the horizontal median values (med1ᵥₑᵣ, med2ᵥₑᵣ, med3ᵥₑᵣ, med4ᵥₑᵣ) calculated by Equations 5 to 8, to be a representative horizontal median value (medᵥₑᵣ).

The texture determiner 220 may select the median value having a smaller value among the representative horizontal median value (medₕₒᵣ) and the representative vertical median value (medᵥₑᵣ) as the representative median value (med) in order to prevent occurrence of two defective pixels in the pixels grouped in the target kernel. The texture determiner 220 may determine whether the target kernel corresponds to a dark region based on the representative median value (med).

The texture determiner 220 may determine whether the target kernel corresponds to a flat region using the representative median value described above. The method for determining the flat region by the texture determiner 220 is represented by Equation 9 below.

$$flat flag = \vert abs ( {G}_{i} = med ) < {th}_{dyn} \vert \leq 2 \qquad [ Equation 9 ]$$

As can be seen from Equation 9, the texture determiner 220 may determine (or set) a threshold (th_{dyn}) based on the representative median value (med). When the number of pixels having a difference (i.e., absolute value ‘abs’) between the representative median value (med) and pixel values (Gᵢ) of the green pixels in the target kernel is equal to or less than the threshold (th_{dyn}) is 2 or less, the texture determiner 220 may determine the corresponding target kernel to be the flat region.

When the dynamic range (i.e., a difference between the maximum value and the minimum value) is used to calculate the deviation of pixel value between pixels when determining the texture, a sorting process may be required. However, when one or more textures are determined in a comparative manner as in the present disclosure, a separate classification process can be omitted, resulting in reduction in the number of calculation operations.

FIG. 5 is a diagram illustrating operations of determining defective pixels by the defective pixel determiner shown in FIG. 2 based on some embodiments of the present disclosure.

FIGS. 5(A) and 5(B) illustrate example cases in which the target kernel corresponds to a green (G) color filter and includes a target pixel (T) arranged in the top row line, as shown in FIG. 3(A) described above. FIGS. 5(C) and 5(D) illustrate example cases in which the target kernel corresponds to a green (G) color filter and includes a target pixel (T) arranged in the bottom row line, as shown in FIG. 3(B) described above.

FIGS. 5(E) and 5(F) illustrate example cases in which the target kernel corresponds to a red (R) color filter and includes a target pixel (T) arranged in the top row line, as shown in FIG. 3(C) described above. FIGS. 5(G) and 5(H) illustrate example cases in which the target kernel corresponds to a red (R) color filter and includes a target pixel (T) arranged in the bottom row line, as shown in FIG. 3(D) described above.

The defective pixel determiner 240 may determine whether the target pixel is a defective pixel based on the first threshold and the second threshold received from the threshold setting circuit 230. That is, when the target kernel is a flat region, the defective pixel determiner 240 may determine whether the target pixel is a defective pixel by comparing a difference value between pixel data of the target pixel and an average pixel value of the reference pixels with the first threshold. On the other hand, when the target kernel is a dark region, the defective pixel determiner 240 may determine whether the target pixel is a defective pixel by comparing a difference value between pixel data of the target pixel and an average pixel value of the reference pixels with the second threshold. In the following description, the first threshold and the second threshold will be collectively referred to as “threshold” or “threshold values”.

The defective pixel determiner 240 may compare pixel data of the target pixel, which is a target object of determination for whether the target pixel is a defective pixel, with the average pixel value of the reference pixels within the target kernel. When a difference value for the comparison result is equal to or greater than the threshold, the defective pixel determiner 240 may determine the target pixel to be a couplet defective pixel that does not have normal pixel data.

As shown in FIG. 3, among a pair of target pixels (P04, P05), the target pixel located on the left side may be defined as the left pixel (CL) (i.e., a first target pixel) and the target pixel located on the right side may be defined as the right pixel (CR) (i.e., a second target pixel). When both the left pixel (CL) and the right pixel (CR) are determined to be defective pixels, the defective pixel determiner 240 may determine the left pixel (CL) and the right pixel (CR) to be “couplet defective pixels”.

For example, as shown in FIG. 5(A), the defective pixel determiner 240 may compare the pixel data of the left pixel (CL) with the average pixel value of the reference pixels (P00, P01, P08, P12, P13, P16, P17, P22, P23, P26, P27, P30, P31, P34, P35, P38, P40, P41, P44, P45) that correspond to the green color and are located adjacent to the left pixel (CL). Then, the defective pixel determiner 240 may determine that the left pixel (CL) is a defective pixel when a difference value according to the comparison result is greater than or equal to a threshold.

As shown in FIG. 5(B), the defective pixel determiner 240 may compare the pixel data of the right pixel (CR) with the average pixel value of the reference pixels (P01, P08, P09, P12, P13, P16, P17, P22, P23, P26, P27, P31, P34, P35, P38, P39, P44, P45, P48, P49) that correspond to the green color and are located adjacent to the right pixel (CR). Then, the defective pixel determiner 240 may determine that the right pixel (CR) is a defective pixel when a difference value according to the comparison result is greater than or equal to a threshold.

Since it can be understood that the remaining target kernels of FIGS. 5(C) to 5(H) are used to determine the defective pixel in the same way as described above, redundant description thereof will herein be omitted for convenience.

The embodiment of FIG. 5 has disclosed that the number of green reference pixels to be compared with the target pixel is 20 and the number of red reference pixels is 12, but the embodiment is not limited thereto, and the number of reference pixels can be suitably changed.

FIG. 6 is a diagram illustrating operations of correcting defective pixels by the defective pixel corrector shown in FIG. 1 based on some embodiments of the present disclosure.

The embodiments illustrated in FIGS. 6(A) and 6(B) may represent example cases in which the target kernel includes a target pixel (T) corresponding to a green (G) color filter. In addition, the embodiments illustrated in FIGS. 6(C) and 6(D) may represent example cases in which the target kernel includes a target pixel (T) corresponding to a red (R) color filter.

When the couplet defective pixel is detected by the defective pixel determiner 240, the defective pixel corrector 300 may correct the couplet defective pixel. For example, the defective pixel corrector 300 may correct only the pixel value of one defective pixel (e.g., the right pixel CR) from among the couplet defective pixels, excluding the pixel value of the remaining defective pixel (e.g., the left pixel CL).

For example, as shown in FIG. 6(A), the left pixel (CL) (P04) may be corrected by averaging the pixel values of the pixel (P05) and the reference pixel (P13). Here, the reference pixel (P13) may be a pixel that is included in a different unit pixel group from the left pixel (CL), is a homogeneous pixel with the left pixel (CL), and is located at the shortest distance from the left pixel (CL). That is, the correction value of the left pixel (CL) (P04) may be calculated by Equation 10 below.

$$P 04 = ( P 13 + P 15 ) / 2 \qquad [ Equation 10 ]$$

As shown in FIG. 6(B), the left pixel (CL) (P04) may be corrected by averaging the pixel values of the pixel (P05) and the reference pixel (P14). Here, the reference pixel (P14) may be a pixel that is included in the same unit pixel group as the left pixel (CL), is a homogeneous pixel with the left pixel (CL), and is located at the closest to (or at the shortest distance from) the left pixel (CL). That is, the correction value of the left pixel (CL) (P04) may be calculated by Equation 11 below.

$$P 04 = ( P 14 + P 05 ) / 2 \qquad [ Equation 11 ]$$

As shown in FIG. 6(C), the left pixel (CL) (P04) may be corrected by averaging the pixel values of the pixel (P05) and the reference pixels (P13, P34). Here, the reference pixels (P01, P34) are pixels that are included in a different unit pixel group from the left pixel (CL), are homogeneous pixels with the left pixel (CL), and are located closest to (at the shortest distance from) the left pixel (CL). That is, the correction value of the left pixel (CL) (P04) may be calculated by Equation 12 below.

$$p 04 = ( 2 \times P 05 + P 01 + P 34 ) / 4 \qquad [ Equation 12 ]$$

As shown in FIG. 6(D), the left pixel (CL) (P04) may be corrected by averaging the pixel values of the pixel (P05) and the reference pixel (P14). Here, the reference pixel (P14) may be a pixel that is included in the same unit pixel group as the left pixel (CL), is a homogeneous pixel with the left pixel (CL), and is located at the shortest distance from the left pixel (CL). That is, the correction value of the left pixel (CL) (P04) may be calculated by Equation 13 below.

$$P 04 = ( P 14 + P 05 ) / 2 \qquad [ Equation 13 ]$$

In the embodiment of FIG. 6, an example of correcting a defective pixel based on the average pixel value of reference pixels of the same type as the target pixel has been described, but the embodiment is not limited thereto. If necessary, the defective pixel can be corrected using the above-described median value and the scope or spirit of the method for correcting the defective pixel is not limited thereto.

For example, the defective pixel corrector 300 may replace the pixel value of the defective pixel with the median value (i.e., the median value from among the pixel values of the reference pixels). For example, the reference pixels may be sequentially enumerated according to the magnitudes of the pixel values thereof, and the pixel value of the defective pixel may be replaced with a pixel value having a median value from among the pixel values of the reference pixels.

FIG. 7 is a diagram illustrating operations of correcting defective pixels by the defective pixel corrector shown in FIG. 1 based on some embodiments of the present disclosure. FIG. 7 shows an embodiment in which, when there is another defective pixel other than the target pixel to be corrected from among pixels of the target kernel, the defective pixel corrector 300 corrects the defective pixel.

The embodiments illustrated in FIGS. 7(A) to 7(D) may represent example cases in which the target kernel includes a target pixel (T) corresponding to a green (G) color filter. In addition, the embodiments illustrated in FIGS. 7(E) to 7(I) may represent example cases in which the target kernel includes a target pixel (T) corresponding to a red (R) color filter. In FIG. 7, a defective pixel in which a defect has occurred will hereinafter be denoted by “x”.

For example, as shown in FIG. 7(A), the left pixel (CL) (P04) may be corrected by averaging the pixel values of the pixel (P05) and the reference pixel (P12). Here, the reference pixel (P12) is a homogeneous pixel included in a different unit pixel group from the left pixel (CL). The homogeneous pixel located closest to the pixel (P04) is the pixel (P13). However, the pixel (P13) is a defective pixel, so that the reference pixel (P12) located close to the left pixel (CL) may be used. That is, the correction value of the left pixel (CL) (P04) may be calculated by Equation 14 below.

$$P 04 = ( P 12 + P 05 ) / 2 \qquad [ Equation 14 ]$$

As shown in FIG. 7(B), the left pixel (CL) (P04) may be corrected using the pixel value of the pixel (P13). Here, the reference pixel (P13) may be a homogeneous pixel included in a different unit pixel group from the left pixel (CL), and may be located at the shortest distance from the left pixel (CL). The homogeneous pixel located closest to the pixel (P04) is the pixel (P05). However, the pixel (P05) is a defective pixel, so that only the reference pixel (P13) may be used. That is, the correction value of the left pixel (CL) (P04) may be calculated by Equation 15 below.

$$P 04 = P 13 \qquad [ Equation 15 ]$$

As shown in FIG. 7(C), the left pixel (CL) (P04) may be corrected by averaging the pixel values of the pixel (P05) and the reference pixel (P15). Here, the reference pixel (P15) is a homogeneous pixel included in the same unit pixel group as the left pixel (CL). The homogeneous pixel located closest to the pixel (P04) is the pixel (P14). However, the pixel (P14) is a defective pixel, so that the reference pixel (P12) located close to the left pixel (CL) may be used. That is, the correction value of the left pixel (CL) (P04) may be calculated by Equation 16 below.

$$P 04 = ( P 15 + P 05 ) / 2 \qquad [ Equation 16 ]$$

As shown in FIG. 7(D), the left pixel (CL) (P04) may be corrected by averaging the pixel values of the reference pixels (P14, P15). Here, the reference pixel (P14) may be a pixel that is a homogeneous pixel located at the shortest distance from the left pixel (CL) while being included in the same unit pixel group as the left pixel (CL). In addition, the reference pixel (P15) may be a pixel located at the second shortest distance from the left pixel (CL) while being included in the same unit pixel group as the left pixel (CL). Whereas the homogeneous pixel located closest to the pixel (P04) is the pixel (P05), the pixel (P05) is a defective pixel, so that the reference pixels (P14, P15) located close to the left pixel (CL) may be used. That is, the correction value of the left pixel (CL) (P04) may be calculated by Equation 17 below.

$$P 04 = ( P 14 + P 15 ) / 2 \qquad [ Equation 17 ]$$

As shown in FIG. 7(E), the left pixel (CL) (P04) may be corrected by averaging the pixel values of the pixel (P05) and the reference pixel (P34). Here, the reference pixel (P34) may be a pixel that is a homogeneous pixel included in a different unit pixel group from the left pixel (CL). Whereas the homogeneous pixels located closest to the pixel (P04) are the pixel (P01) and the pixel (P34), the pixel (P01) is a defective pixel, so that the reference pixel (P34) may be used. That is, the correction value of the left pixel (CL) (P04) may be calculated by Equation 18 below.

$$P 04 = ( 3 \times P 05 + P 34 ) / 4 \qquad [ Equation 18 ]$$

As shown in FIG. 7(F), the left pixel (CL) (P04) may be corrected by averaging the pixel values of the reference pixels (P01, P34). Here, the reference pixels (P01, P34) are homogeneous pixels included in a different unit pixel group from the left pixel (CL). Whereas the homogeneous pixel located closest to the pixel (P04) is the pixel (P05), the pixel (P05) is a defective pixel, so that the reference pixels (P01, P34) located close to the left pixel (CL) can be used. That is, the correction value of the left pixel (CL) (P04) may be calculated by Equation 19 below.

$$P 04 = ( P 01 + P 34 ) / 4 \qquad [ Equation 19 ]$$

As shown in FIG. 7(G), the left pixel (CL) (P04) may be corrected by averaging the pixel values of the pixel (P05) and the reference pixel (P01). Here, the reference pixel (P01) is a homogeneous pixel included in a different unit pixel group from the left pixel (CL). Whereas the homogeneous pixels located closest to the pixel (P04) are the pixel (P01) and the pixel (P34), the pixel (P34) is a defective pixel, so that the reference pixel (P01) can be used. That is, the correction value of the left pixel (CL) (P04) may be calculated by Equation 20 below.

$$P 04 = ( 3 \times P 05 + P 01 ) / 4 \qquad [ Equation 20 ]$$

Since it can be understood that the target kernels of FIGS. 7(H) and 7(I) are used to correct the defective pixel in the same way as described above, redundant description thereof will herein be omitted for convenience.

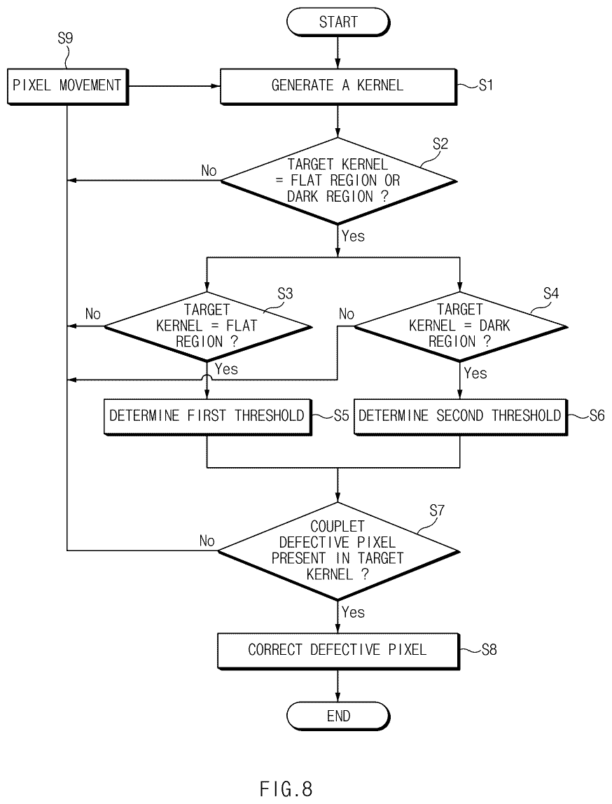

FIG. 8 is a flowchart illustrating operations of the image signal processor (ISP) shown in FIG. 1 based on some embodiments of the present disclosure.

Referring to FIG. 8, the kernel generator 210 may generate a kernel for determining defective pixels (Operation S1). The kernel generated by the kernel generator 210 may move within the input image. For example, the kernel generator 210 may generate a kernel while scanning the image data (IDATA) in the direction from the upper left end to the lower right end of the image data (IDATA) formed in a matrix array and moving a distance corresponding to two pixels to the right side of the image data (IDATA) for each scanning action.

Thereafter, the texture determiner 220 may determine whether the target kernel corresponds to a flat region or a dark region by targeting the kernel generated by the kernel generator 210 (Operation S2).

Subsequently, the texture determiner 220 may determine whether the target kernel corresponds to a flat region (Operation S3). Here, the target kernel serving as a flat region may mean that the target kernel is a kernel included in the flat region.

The threshold setting circuit 230 may determine (or set) the first threshold when the target kernel is determined to be a flat region (Operation S5). For example, the threshold setting circuit 230 may determine (or set) the first threshold based on brightness of the target pixel when the target kernel is a flat region.

When the target pixel is a green pixel, the threshold setting circuit 230 may determine (or set) the first threshold by summing the representative median value (med), the threshold value (th_{dyn}), and the offset value which are obtained by the texture determiner 220.

In addition, when the target pixel is a color pixel (e.g., a red or blue pixel), the threshold setting circuit 230 may determine the first threshold using pixel data of homogeneous (similar characteristic) pixels having the same attributes as the target pixel, from among the pixels included in the target kernel. Here, the pixels having the same attributes as the target pixel may correspond to pixels corresponding to the same color filter or the same channel as the target pixel. In addition, the same channel may refer to the position of pixels having the same relative position from the center point of a microlens. For example, the threshold setting circuit 230 may determine (or set) the first threshold by calculating a minimum value from among the pixel values of a predetermined number (e.g., 18) of the same pixels and then summing the offset values.

The texture determiner 220 may determine whether the target kernel corresponds to the dark region (Operation S4). Here, the target kernel serving as the dark region may mean that the target kernel is a kernel included in the dark region.

The threshold setting circuit 230 may determine (or set) the second threshold when the target kernel is determined to be the dark region (Operation S6). For example, the threshold setting circuit 230 may set the second threshold to a predetermined constant value in consideration of an analog gain or a digital gain because the threshold setting circuit 230 is activated only in a dark texture mode when the target kernel is a dark region.

Subsequently, the defective pixel determiner 240 may determine a reference pixel group including at least one reference pixel to be compared with a unit pixel group including the target pixel within the target kernel. The defective pixel determiner 240 may compare the pixel data of the target pixel with the pixel data of the reference pixels. The defective pixel determiner 240 may determine whether the target pixel is a couplet defective pixel by comparing a difference value obtained by comparing the pixel data of the target pixel with the pixel data of the reference pixels with the above-described threshold (Operation S7).

For example, when the difference between the threshold value included in the threshold information and the difference value is greater than or equal to a preset difference value, the defective pixel determiner 240 may determine the target pixel to be a defective pixel. For example, when the target kernel corresponds to a flat region and a difference between the first threshold and the difference value is greater than or equal to a preset difference value, the defective pixel determiner 240 may determine the target pixel to be a defective pixel. For example, when the target kernel corresponds to a dark region and a difference between the second threshold and the difference value is greater than or equal to a preset difference value, the defective pixel determiner 240 may determine the target pixel to be a defective pixel.

When the defective pixel determiner 240 determines that the target pixel is not a defective pixel (No in S7), the defective pixel determiner 240 may proceed to operation S9. Then, the kernel generator 210 may generate an operation kernel for detecting a defective pixel by moving a distance corresponding to two unit pixels (Operation S9).

Subsequently, the defective pixel corrector 300 may interpolate pixel data of the couplet defective pixel by using pixel data of the pixels included in the target kernel when the couplet defective pixel is detected as a result of the determination of the defective pixel determiner 240 (Operation S8). In the present disclosure, a pixel value of one defective pixel from among the couplet defective pixels may not be corrected and may be excluded without correction, so that the pixel value of the one defective pixel may not be included in the image data (IDATA_P). Then, only the pixel value of the remaining one defective pixel may be corrected to generate the corrected image data (IDATA_P) including the data of the interpolated target pixel.

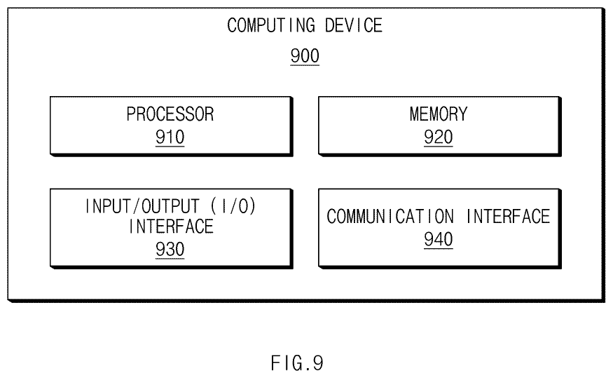

FIG. 9 is a block diagram showing a computing device 900 corresponding to the image signal processor of FIG. 1.

Referring to FIG. 9, the computing device 900 may represent an embodiment of a hardware configuration for performing the operation of the image signal processor 100 of FIG. 1.

The computing device 900 may be mounted on a chip that is independent from the chip on which the image sensing device is mounted. According to one embodiment, the chip on which the image sensing device is mounted and the chip on which the computing device 900 is mounted may be implemented in one package, for example, a multi-chip package (MCP), but the embodiment is not limited thereto.

Additionally, the internal configuration or arrangement of the image sensing device and the image signal processor 100 described in FIG. 1 may vary depending on the embodiment. For example, at least a portion of the image sensing device may be included in the image signal processor 100. Alternatively, at least a portion of the computing device 900 may be included in the image sensing device. In this case, at least a portion of the computing device 900 may be mounted together on a chip on which the image sensing device is mounted.

The computing device 900 may include a processor 910, a memory 920, an input/output interface 930, and a communication interface 940.

The processor 910 may process data and/or instructions required to perform the operations of the components (200, 300) of the image signal processor 100 described in FIG. 1. That is, the processor 910 may refer to the image signal processor 100, but the embodiment is not limited thereto.

The memory 920 may store data and/or instructions required to perform operations of the components (200, 300) of the image signal processor 100, and may be accessed by the processor 910. For example, the memory 920 may be volatile memory (e.g., Dynamic Random Access Memory (DRAM), Static Random Access Memory (SRAM), etc.) or non-volatile memory (e.g., Programmable Read Only Memory (PROM), Erasable PROM (EPROM), etc.), EEPROM (Electrically Erasable PROM), flash memory, etc.).

That is, the computer program for performing the operations of the image signal processor 100 disclosed in present disclosure is recorded in the memory 920 and executed and processed by the processor 910, thereby implementing the operations of the image signal processor 100.

The input/output interface 930 is an interface that connects an external input device (e.g., keyboard, mouse, touch panel, etc.) and/or an external output device (e.g., display) to the processor 910 to allow data to be transmitted and received.

The communication interface 940 is a component that can transmit and receive various data with an external device (e.g., an application processor, external memory, etc.), and may be a device that supports wired or wireless communication.

As is apparent from the above description, the image signal processor based on some embodiments of the present disclosure can more accurately detect and correct defective pixels even when two or more defective pixels exist adjacent to each other.

The embodiments of the present disclosure may provide a variety of effects capable of being directly or indirectly recognized through the above-mentioned technology.

Although a number of illustrative embodiments have been described, it should be understood that modifications and enhancements to the disclosed embodiments and other embodiments can be devised based on what is described and/or illustrated in the present disclosure. Furthermore, the embodiments may be combined to form additional embodiments.

What is claimed is:

1. An image signal processor comprising:
a kernel generator configured to generate a target kernel including a pair of adjacent target pixels;
a texture determiner configured to determine whether the target kernel corresponds to a flat region or a dark region by analyzing a texture of the target kernel;
a threshold setting circuit configured to determine a threshold based on a result of the determination of the texture determiner;
a defective pixel determiner configured to determine, based on pixel data of reference pixels having a same attribute as the pair of target pixels, whether each of the target pixels is a defective pixel; and
a defective pixel corrector configured to correct one of the target pixels when the target pixels are determined as defective pixels.

2. The image signal processor according to claim 1, wherein the target kernel is an asymmetric kernel that includes a plurality of pixels arranged in an (M×N) matrix structure including M rows and N columns, where M and N are different natural numbers,
wherein
the number of M rows is greater than the number of N columns.

3. The image signal processor according to claim 1, wherein the kernel generator is configured to:
generate the target kernel by moving pixels in units of two pixels within an input image.

4. The image signal processor according to claim 1, wherein:
the target kernel includes a plurality of pixels corresponding to a same color filter,
the plurality of pixels include the pair of target pixels, and
adjacent pixels are grouped within the plurality of pixels.

5. The image signal processor according to claim 1, wherein the target pixels correspond to a same color filter and are located adjacent to each other within a same unit pixel group.

6. The image signal processor according to claim 1, wherein the texture determiner is configured to:
determines the target kernel as the flat region or the dark region based on a median value of the target pixels and a predetermined number of the reference pixels.

7. The image signal processor according to claim 6, wherein the texture determiner is configured to:
determine a first representative median value by grouping a specific number of pixels arranged adjacent in a first direction from among a plurality of pixels included in the target kernel;
determine a second representative median value by grouping a specific number of pixels arranged adjacent in a second direction different from the first direction from among the plurality of pixels; and
determine the dark region based on a smaller representative median value from among the first representative median value and the second representative median value.

8. The image signal processor according to claim 7,
wherein the texture determiner is configured to:
determine a threshold based on the representative median value; and
when a difference between the representative median value and pixels corresponding to a green color filter in the target kernel is less than or equal to 2, determine a corresponding target kernel to be the flat region.

9. The image signal processor according to claim 1,
wherein the threshold setting circuit is configured to:
when the target kernel is the flat region, determine the threshold to be a first threshold based on brightness of the pair of target pixels; and
when the target kernel is the dark region, determine the threshold to be a second threshold having a fixed constant value.

10. The image signal processor according to claim 9,
wherein the texture determiner is further configured to determine a threshold and an offset value, and
wherein the threshold setting circuit is configured to:
when the pair of target pixels is pixels corresponding to a green color filter, determine the first threshold based on a median value of the reference pixels and a threshold and an offset value that are determined by the texture determiner.

11. The image signal processor according to claim 1,
wherein the reference pixels are configured to: include at least one color filter having a same color as a color filter corresponding to at least one of the target pixels, and
wherein the reference pixels are located in a different unit pixel group from the pair of target pixels.

12. The image signal processor according to claim 1,
wherein the pair of target pixels comprise first and second target pixels,
wherein the defective pixel determiner is configured to:
determine the first target pixel to be the defective pixel when a difference between pixel data of a first target pixel from among the pair of target pixels and an average value of pixel data of first reference pixels located around the first target pixel is equal to or greater than the threshold; and
determine the second target pixel to be the defective pixel when a difference between pixel data of a second target pixel from among the pair of target pixels and an average value of pixel data of second reference pixels located around the second target pixel is equal to or greater than the threshold, and
wherein the first and second reference pixels are included in the reference pixels.

13. The image signal processor according to claim 12, wherein the defective pixel determiner is further configured to determine both the first and second target pixels as couplet defective pixels when both the first and second target pixels are determined as defective pixels.

14. The image signal processor according to claim 13, wherein the defective pixel corrector is configured to:
when the couplet defective pixel is determined, correct a pixel value of the first target pixel, except for a pixel value of the second target pixel.

15. The image signal processor according to claim 13, wherein the defective pixel corrector is configured to:
correct the first target pixel by averaging pixel values of the reference pixels.

16. The image signal processor according to claim 13, wherein the defective pixel corrector is configured to:
correct the first target pixel using a median value of the reference pixels.

17. An image signal processor comprising:
a texture determiner configured to determine kernel type information by analyzing a texture of a target kernel including a pair of adjacent target pixels;
a threshold setting circuit configured to determine a threshold based on the kernel type information;
a defective pixel determiner configured to determine, based on the threshold, whether each of the pair of target pixels is a defective pixel; and
a defective pixel corrector configured to correct one of the target pixels when the target pixels are determined as defective pixels.

18. The image signal processor according to claim 17, wherein the texture determiner is configured to: determines the kernel type information based on whether the target kernel corresponds to a flat region or a dark region.

19. The image signal processor according to claim 17, wherein the target pixels correspond to a same color filter and are located adjacent to each other within a same unit pixel group.

20. The image signal processor according to claim 17,
wherein the pair of target pixels comprise first and second target pixels,
wherein the defective pixel determiner is configured to:
determine the first target pixel to be the defective pixel when a difference between pixel data of a first target pixel from among the pair of target pixels and an average value of pixel data of first reference pixels located around the first target pixel is equal to or greater than the threshold; and
determine the second target pixel to be the defective pixel when a difference between pixel data of a second target pixel from among the pair of target pixels and an average value of pixel data of second reference pixels located around the second target pixel is equal to or greater than the threshold.
